(19) United States
(12) Patent Application Publication
(10) Pub. No.: US 2015/0027010 A1
(43) Pub. Date: Jan. 29, 2015

(54) Aircraft Banner

(71) Applicant: Publiavia Ltd., Biggleswade, Bedfordshire (GB)

(72) Inventor: Wayne Mansfield, Boxford, MA (US)

(21) Appl. No.: 14/370,587

(22) PCT Filed: Jan. 4, 2013
(86) PCT No.: PCT/GB2013/050008

§ 371 Date: Jul. 3, 2014

(30) Foreign Application Priority Data
Jan. 4, 2012 (GB) 1200098.0

(51) Int. Cl. G09F 19/14; G09F 21/12

(52) U.S. Cl. CPC G09F 19/14; G09F 21/12
USPC 40/215; 40/212

(57) ABSTRACT

An aircraft banner comprises an image, with at least a section thereof being visually adaptive with respect to the location of an observer thereof. The banner presents a moving or changing image thereon in the eyes of the observer during use. The moving or changing image moves or changes as the aircraft banner moves relative to the observer.

The present invention relates to an aircraft banner—also known as an aerial banner, and new applications therefor.

Advertising space is increasingly becoming a premium item and new modes for providing advertising space are always in demand. For many years aircrafts have been towing aircraft banners and these aerial banners are readily adaptable between lettering, posters and streamers so as to allow them to advertise a particular show, film or product. It would be desirable, however, to increase the ability for such posters to catch the eye of a viewer.

According to the present invention there is provided an aircraft banner comprising an image, at least a section thereof being visually adaptive with respect to the location of an observer thereof, whereby the banner presents a moving or changing image thereon in the eyes of the observer such that in use the moving or changing image will move or change as the aircraft banner moves relative to the observer. The moving or changing image will cause the banner more readily to catch the eye of the observer since a moving or changing image typically stands out more than a corresponding non-changing, 2D, fixed image.

Preferably the aircraft banner is towed behind an aircraft, such as an aeroplane. Alternatively, the aircraft banner may be carried underneath an aircraft, such as a helicopter. In further embodiments, the aircraft banner may be attached to the side or underside of an aircraft, such as an aeroplane or helicopter, or it may be towed or lifted, or affixed to a surface of, some other aircraft, such as a microlite, an airship, a hot air balloon, or an airliner.

The part of the aircraft banner that has the moving or changing image may occupy only a small part of the aircraft banner. Alternatively it may occupy substantially the whole extent of the aircraft banner, or some amount therebetween. For example, for a design where it occupies only a small part of the aircraft banner, it could occupy an area of interest, such as an item of clothing, or a face of a person, or a body of a person, or a given frame or screen shot incorporating that area of interest, or a given character/person/scene on the aircraft banner, whereby the clothing or the face or the framed image can move or change as the aircraft banner moves relative to the observer, which change or movement will catch the attention of the observer. This, for example, could be used to change the colour of the clothing, or to change the expression on the face of the character, or to provide movement to the person or character, or to switch from one scene to another, or to rotate an illustrated object, or to move the eyes of a character, or to enhance a feature of the image—e.g. to give the illusion of a third dimension.

The portion featuring the enhancement or the moving/changing image may even comprise lettering, whereby the moving or changing image is a changing of the lettering, e.g. to switch from one set of words to another.

Alternatively, more than one different image may be being presented as the aircraft banner moves relative to the observer, for example for advertising more than one film or show, or for promoting two or more different or related products, or for advertising different parts of a particular film, show or product, or for advertising the motion of a product, such as by rotating a product.

The portion of the aircraft banner carrying the changeable imagery may be contained within a rigid frame, or on a rigid background, whereby the medium on which the changeable image is provided can be retained in a taut or flat condition, thus facilitating or improving upon the correct viewability of the changing image as the aircraft banner moves relative to an observer.

Aircraft banners already exist that can retain the banner in a relatively taut or flat condition as it is towed or suspended by an aircraft. One such solution uses a leading-edge bar for holding the leading edge in a straight, flat plane, coupled with and a wind resistive tail (or in the case of a suspended design a weighted free end) for pulling the trailing part of the aircraft banner in that same flat plane. Depending on the technology used for the banner, and the element thereof which carries the changeable image, either the full frame around the changeable image part, or the existing aircraft banner flattening technologies may be adequate for providing the planar presentation of the sheet carrying the changing/moving image.

It is preferred that the portion carrying the adaptive image is sewn into the remaining part of the banner without any stiffening frame or backing plate. A frame or backing plate can make the banner as a whole less stable in the air, even though the adaptive part may be kept flat. This is because of the weight/thickness of the frame/backing plate is typically higher than the weight of the fabric of the banner.

Preferably the portion of the aircraft banner featuring the changeable image comprises a holographic image or an image that give an impression of a third dimension—depth, in addition to the usual width and height.

A preferred form for the portion is a lenticular image—one that presents a first image from one angle, and a different image from a different angle. Lenticular images can even provide third and fourth and more images from yet further angles. The angles may be angles relative to a horizontal axis, or relative to a vertical axis, or both, or where rotated, in other angular directions.

These “moving/changing image” posters are commonly known as “3D posters”.

Such “3D posters”, and the production or printing/processing technologies used for making them, are well known to the advertising market, be that in the holographic, 3D or lenticular form. However, to date they have not been known in the area of airborne advertising since the perceived depth of the 3D image was not recognised to be useable from the distances used in such airborne applications. Indeed, many printing forms lose their effect if viewed from more than a few feet away. Nevertheless, the lenticular forms can be usefully used e.g. to change from one image to another, and that can be very effective on airborne banners.

Companies such as Tracer 1, Pyramid International and Big 3D already product large format 3D posters and they have used them on the sides of buildings and on the sides of trucks. The present inventors, however, have identified the new airborne use for these posters as identified above, which opens up a new application for airborne advertising.

These an other features of the present invention will now be described in further detail below with reference to the accompanying drawings, in which:

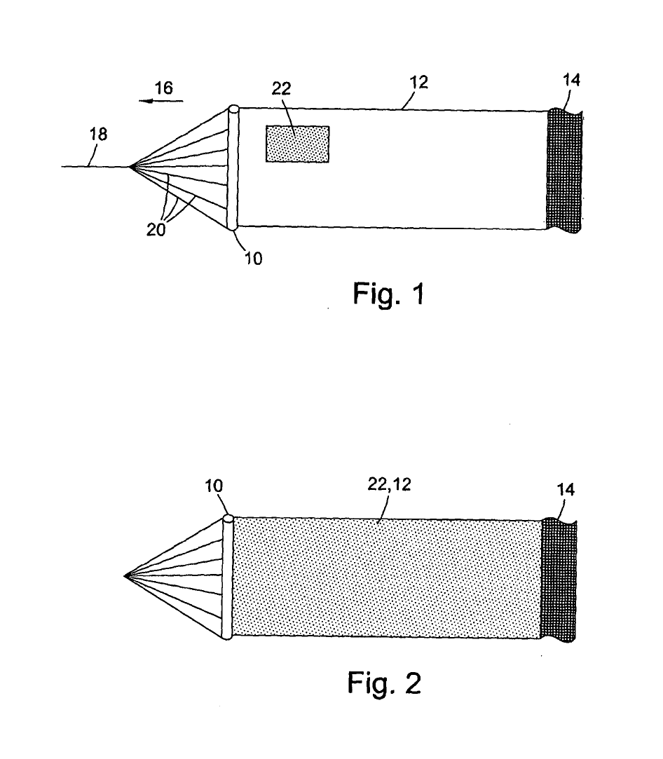

FIG. 1 shows an aerial banner with a 3D and/or lenticular panel incorporated therein;

FIG. 2 shows an aerial banner in which substantially the whole extent of the aerial banner comprises a 3D and/or lenticular banner;

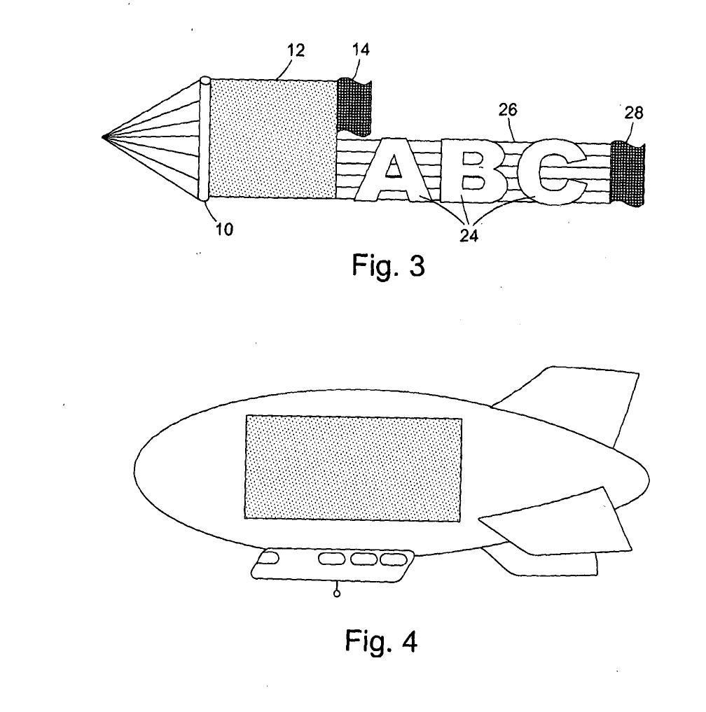

FIG. 3 shows a combination of an aerial logo banner, with letters, attached to a 3D lenticular panel;

FIG. 4 shows an airship—either a dirigible or blimp—with a 3D and/or lenticular panel on a side thereof;

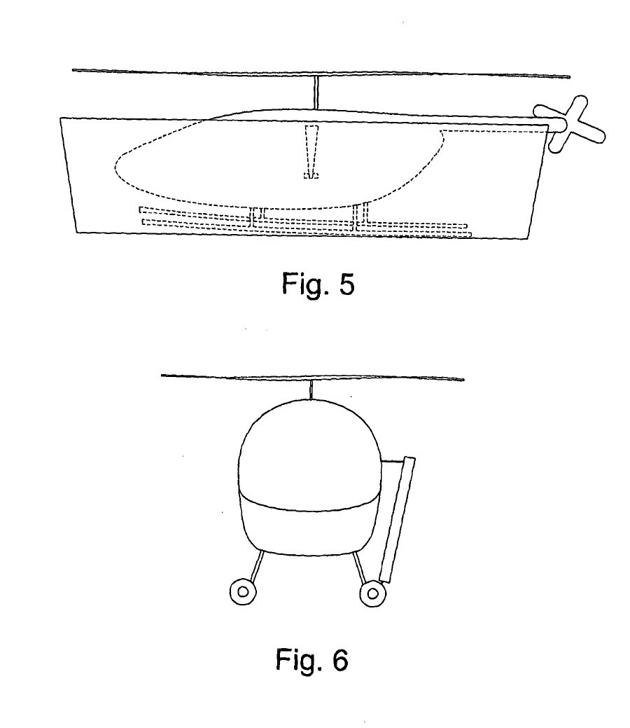

FIG. 5 and FIG. 6 show a side and front view of a helicopter with a 3D and/or lenticular panel mounted on its side;

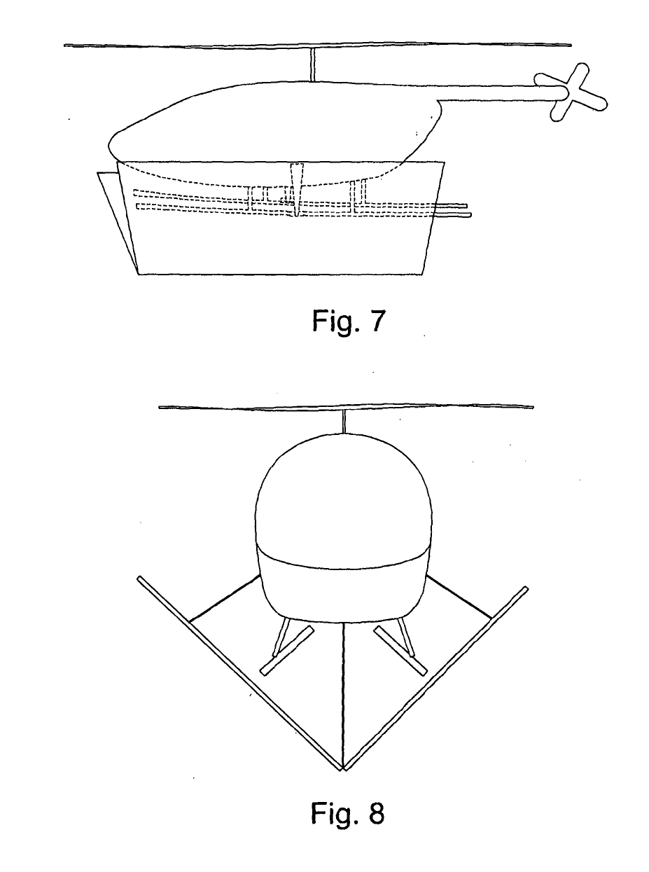

FIGS. 7 and 8 show a further design of helicopter with 3D and/or lenticular panels suspended on a sling mount, in a V shaped formation, viewed respectively from the side and the front thereof, with the panels being mounted and braced to the skids;

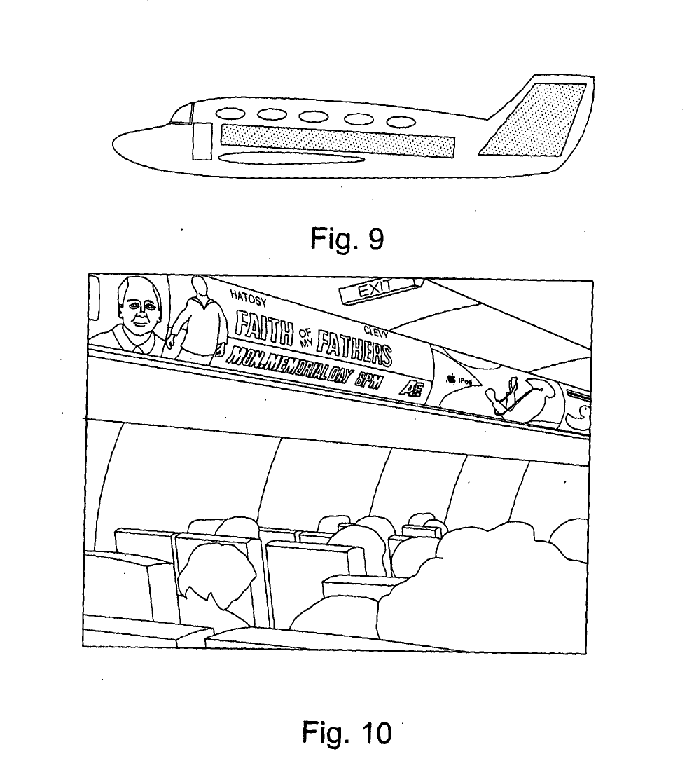

FIG. 9 schematically shows a light aircraft with 3D and/or lenticular panels attached to the side and tail fin thereof;

FIG. 10 shows the inside of an aircraft in which the luggage bins have 3D posters attached thereto—illustrated purely as a mock up;

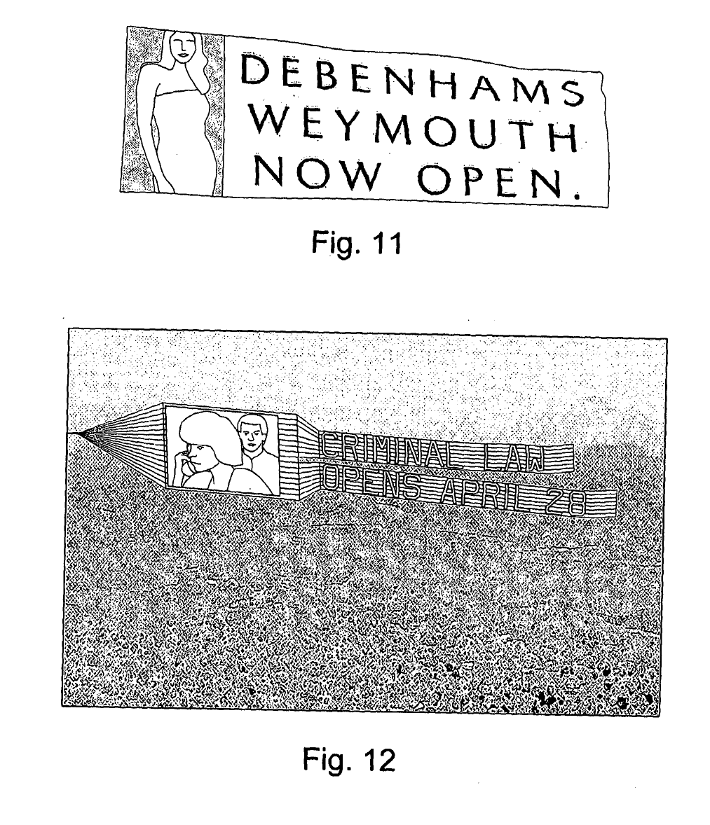

FIG. 11 shows an aircraft banner having a combination of a model and words thereon;

FIG. 12 shows an example where a television programme advertisement is combined with wording;

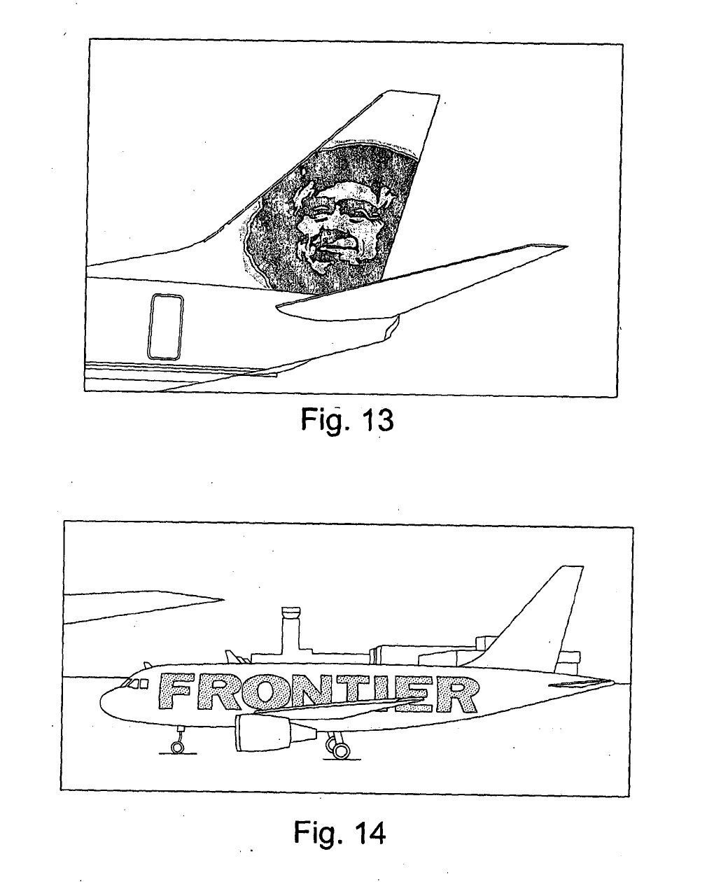

FIG. 13 shows a tail fin of an airliner having characteristics suitable for enhancement by the present invention; and

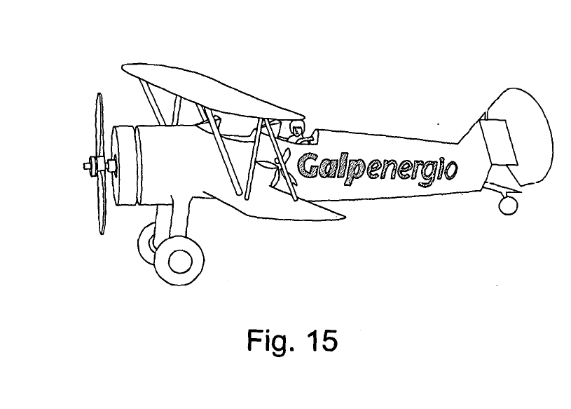

FIGS. 14 and 15 show further aircraft on which the present invention may be incorporated either on the sides thereof or on, for example, the undersides of the wings.

Holographic posters and other 3D or lenticular posters, have been used for advertising panels and banners and they can enhance the advertisements compared to standard 2D images by offering an added dimension thereto. They can be combined as a component of the aerial banner, or as an entire aerial banner, or as an advertisement attached to helicopters, airships, or larger and other aircraft surfaces such as executive jets and airliners or on non-commercial aircraft such as private small to medium size aircraft and hot air balloons and the like.

Aerial banners, sometimes known as Skyboards®, are typically comprised of lightweight cloth panels that are normally decorated by digital printing processes. Some are painted by hand or may be produced by other processes such as screen printing. The addition thereto proposed by the present invention is that of the 3D technologies such as 3D and/or lenticular panels. This will enhance those prior art airborne banners since they would allow the image to change as the aerial banner moves relative to an observer, whereby a single banner can present more than one image to the observer, and possibly the impression of a moving image.

In the example shown in FIG. 11, for example, the banner may incorporate a lenticular image including the picture of the woman, whose dress could change from red to green, or from blue to orange, or some other colour/appearance change, as the banner moves relative to the observer. That change would naturally catch the eye of the observer, thus drawing the observers attention to the banner's content more readily than a standard 2D banner.

Likewise, the wording could change as the banner moves relative to the observer, or some other additional information or visual effect could be provided by way of the changing/moving image.

Referring next to FIG. 12, instead of providing a visual change to the clothing, the characters in the graphic could be given the impression of moving within the poster as the banner moves relative to an observer, for example by having the characters' faces face forwards, towards the observer, as the banner approaches, and then backwards, still towards the observer, after the banner has passed by.

The banners could even be fixed (permanently or changeable) to the sides or undersides of an aircraft, such as to the tail fin thereof, as shown in FIGS. 13 and 14 and 9, or onto the sides of the aircraft as shown in FIGS. 9 and 14 and 4.

Further, instead of fixed images mounted directly onto the sides of the aircraft, they could be provided on removable panels, whereby the images can be changed or updated with the panels perhaps being held tight within an adjustable frame.

In addition, lightweight panels can be applied as advertisements under the wings of aircraft, with the 3d posters being applied thereto.

Particular applications that could have significant commercial application would be on the sides or undersides of airliners either promoting the brands of the airliners, or of some other product, or of resort destinations. For example, a 3D Mickey Mouse logo on the side or tail of an aircraft could be provided for the Disney franchisers, such as Disneyworld in Orlando, Fla. Another example might be a changing lenticular face of the native Alaskan shown in FIG. 13—featured on Alaska Airline aircraft tails.

It is preferred that the lenticular panels are incorporated into the aircraft banners in as thin (or streamlined) a manner as possible. Blended edges on any frame or backing are thus desireable.

One known form of aerial banner is sold under the trademark SKYBOARD®, and their banners are a preferred medium into which to incorporate the adaptive image of the present invention. That is since SKYBOARD® banners have received UKCAA approval for flight as airworthiness approval note no. 23519, whereby they are permitted for use in the UK. In the US, however, there is less of a legislative burden on aerial banners—there is currently no specific requirement for such approvals. Nevertheless, the panels/banners sold under the SKYBOARD trademark are a suitable starting point for adding an adaptive image for the banner since their infrastructure is already constructed to withstand the wind sheer forces to which such aerial banners are exposed. They are typically constructed of a lightweight nylon cloth similar to a sail cloth and are coated with urethane on one side in order that they can be printed upon by digital printers. Such a construction is therefore preferred, and such structures may be provided by other manufacturers too, i.e. not under the SKYBOARD trademark.

3D and/or lenticular panels or posters may be inserted into or incorporated onto these aerial banners, for example by means of stitching or adhesive tapes, such as the pico brand double sided sail tape, and the assembly can then be reinforced with Dacron sail patch tape which is then stitched by sewing. This arrangement then results in a secure and relatively streamlined attachment. Other sail patching techniques may also be appropriate for the purpose of incorporation of the adaptive poster portion into the banner.

Designs of banner may alternatively be suitable for addition to the sides or undersides of airships, and for example can work like SKYBOARD banners with the added possibility to produce a semi-rigid 3D lenticular sign to attach to either the blimp's bag or the rigid frame of a dirigible.

Other arrangements may have a helicopter either towing or suspending the aerial banner, the banner having e.g. a 3D/lenticular panel (or more than one such panel—equally applicable to the other embodiments) incorporated therein. Helicopters might even be provided where the signage incorporating the 3D/lenticular panels is attached to the skids, or elsewhere on the underside of the helicopter. Such helicopter designs are shown schematically in FIGS. 5 to 8. Substantially vertical arrangements are more preferred, however, since they will more readily allow the down draft from the rotors to pass, thus interfering less with the helicopter's performance. For example, a vertical panel may be mounted on either side of the helicopter in place of the V-shaped formation illustrated.

Referring now to FIG. 1, a 3D and/or lenticular panel is shown to be attached to an aerial banner. It can be attached thereto in any one of many ways, including any of the known repair techniques used for sails, such as common systems using tapes and sewing. Alternatively a fixed frame may be mounted within the banner, with the adaptive poster or portion being mounted within that frame. Preferably, however, the adaptive/3D/lenticular poster is attached initially to a rear face of the banner, and is aligned with the image presented on the underlying non-3D (standard banner) graphic.

The overlied non-3D portion is then removed to reveal the matching 3D lenticular portion through the resulting aperture in the original banner.

At the leading edge of the aerial banner there is provided a banner flattening bar 10. It holds the banner 12 in a substantially flat configuration at that leading edge. Then a wind resistive tail 14 cooperates therewith when the banner is flying to tighten the banner 12 into a substantially rigid planar configuration, i.e. as the banner is towed at speed by the aeroplane in the forward direction 16. The banner is attached to the aeroplane in a conventional manner using a wire or rope 18 attached at the front of the banner by plurality of wires or ropes 20.

The 3D lenticular panel 22, in this first embodiment, occupies just a small fraction of the overall area of the panel or banner 12.

Referring next to FIG. 2, the adaptive panel 22 now occupies substantially the entire printed area of the banner 12. There is still the wind resistive tail 14 and the bar 10 at the front. However, it is effectively the whole of the banner that now has the adaptive imagery, i.e. a 3D/lenticular image thereon. This is a preferred arrangement, but manufacturing such a large lenticular poster is costly, whereby there could be commercial limitations in implementing such a design.

Referring next to FIG. 3, another arrangement is shown. A stiff leading edge 10 is again provided, and behind that it has a front portion of the banner 12 formed of a lenticular panel. However, a tail therefrom then features a plurality of letters 24 formed on a plurality of strings 26 (or on a clear backing), that tail then also having a wind resistive tail 28 to keep it tight in flight. The tail extends, in this embodiment, from the bottom of the lenticular panel, whereby the top half of the panel then has its own wind resistive tail 14.

The wind resistive tail can be streamers or a surface coating (or treatment) for increasing the wind resistivity of the tail portion. It functions to tighten the panel in flight.

These banners, via their lenticular (or other 3d or adaptive “moving” or “changing” images), offer a greater depth of imagery on the banner, and also the opportunity for eye-catching movement to be provided as the banner moves relative to an observer.

Although it has been discussed above that the lenticular panel or poster may be affixed to a solid background or a frame, this is only preferred given that lenticular posters function best if securely maintained in a planar configuration. However, as per the description of fitting it by tapes and sewing, it is purely optional to use a frame or backing. After all, it may be preferred that the panel simply retains its own rigidity due to the motion of the banner through the air, e.g. through the use of the front bar and the rear wind-resistive tail. After all, such techniques already adequately hold 2D, non-image-changing banners in a substantially rigid, planar condition. A rigid frame may compromise the flying characteristics of the banner if it is being towed.

Bear in mind too that a frame or a backing panel could also make that part of the banner have a greater localised mass per unit area than the rest of the banner, which could disrupt the banner's flying properties—it could create creasing on the remaining part of the banner 12.

Preferably the lenticular panel (or the other form of 3D or adaptive, “moving” or “changing” image poster) is double-sided so that observers on both sides of a passing banner can be provided the moving or changing image effect.

The present invention, in its preferred embodiments, relates purely to flying banners, be that free-flying in the sense of being towed or suspended, or fixed, as in aircraft mounted. The present invention is not intended to extend to ground based installations, such as posters fixed to buildings or trucks.

It is also preferred that the banners of the present invention are designed to be observed from afar—as will typically be the case with airborne applications. For that purpose, certain 3D printing techniques, including holographic images, are less well adapted to these airborne applications since the 3D effect has a perceived depth of only a few feet at best, whereby they can only be appreciated from close viewing distances. Lenticular posters, however, are particularly well adapted to these longer range scenarios since the perceived depth is less of an issue—instead the image changes depending upon the viewing angle. Further, the extent of image change achievable with lenticular designs is potentially more dramatic, although more limited in terms of the detail. Those dramatic changes, i.e. from one image to a different image, however, can be used to offer an eye-catching effect on an aerial banner, such as changing of the direction of a face, changing the colour of a piece of clothing, or changing the illustrated caption. These changes—unachievable with conventional 2D posters—will add to the value of aerial banners due to this increased ability to catch the eye of an observer from afar, thus increasing the value of the advertising space.

The present invention has been described purely by way of example. Modifications in detail may be made to the invention within the scope of the claims appended hereto.

What is claimed is:

1. An aircraft banner comprising an image, at least a section thereof being visually adaptive with respect to the location of an observer thereof, whereby the banner will present a moving or changing image thereon in the eyes of the observer during use, the moving or changing image moving or changing as the aircraft banner moves relative to the observer.

2. The aircraft banner of claim 1, wherein the aircraft banner is being towed behind an aircraft, such as an aeroplane.

3. The aircraft banner of claim 1, wherein the aircraft banner is being carried underneath an aircraft, such as a helicopter.

4. The aircraft banner of claim 1, wherein the aircraft banner is attached to the side or underside of an aircraft, such as an aeroplane or helicopter or microlite or airship or hot air balloon.

5. The aircraft banner of claim 1, wherein the section of the aircraft banner that is visually adaptive occupies less than 20% of the image.

6. The aircraft banner of claim 1, wherein there are two or more of the sections of the aircraft banner that are visually adaptive.

7. The aircraft banner of claim 6, wherein each section occupies less than 20% of the image.

8. The aircraft banner of claim 1, wherein the section of the aircraft banner that is visually adaptive occupies substantially the whole extent of the image.

9. The aircraft banner of claim 1, wherein the image comprises a printed image.

10. The aircraft banner of claim 1, wherein the section of the aircraft banner that is visually adaptive is contained within a rigid frame.

11. The aircraft banner of claim 1, wherein the section of the aircraft banner that is visually adaptive is on a rigid background.

12. The aircraft banner of claim 1, wherein the section of the aircraft banner that is visually adaptive is retained in a relatively taut or flat condition as it is towed or suspended by an aircraft using a leading-edge bar for holding the leading edge in a straight, flat plane, and either a wind resistive tail or a weighted free end.

13. The aircraft banner of claim 1, wherein the section of the aircraft banner that is visually adaptive is taped or stitched, or both, into the banner.

14. The aircraft banner of claim 1, wherein the section of the aircraft banner that is visually adaptive comprises a holographic image.

15. The aircraft banner of claim 1, wherein the section of the aircraft banner that is visually adaptive comprises a 3D printed image.

16. The aircraft banner of claim 1, wherein the section of the aircraft banner that is visually adaptive comprises a lenticular image.

17. The aircraft banner of claim 1, wherein the section of the aircraft banner that is visually adaptive comprises a lenticular image with more than two presentable images, each selectively viewable by an observer as the image is moved relative to the observer due to the change in the angle of viewing of the image by the observer.

18. A method of advertising comprising mounting an aerial banner on or relative to a flying object such as an aircraft, the aerial banner including at least a section thereof that is visually adaptive with respect to the location of an observer thereof, and flying the flying object with its areal banner past an observer, the aerial banner thereby presenting a moving or changing image thereon to the eyes of the observer as the aircraft banner moves relative to the observer.
